(19) United States
(12) Patent Application Publication
(10) Pub. No.: US 2016/0234751 A1
(43) Pub. Date: Aug. 11, 2016

(54) RADIO ACCESS TECHNOLOGY MANAGEMENT

(71) Applicant: VODAFONE IP LICENSING LIMITED, Newbury, Berkshire (GB)

(72) Inventors: Assen GOLAUP, Newbury, Berkshire (GB); Christopher PUDNEY, Newbury Berkshire (GB); Neil SCULLY, Newbury Berkshire (GB); Ralf IRMER, Newbury Berkshire (GB); Luke IBBETSON, Newbury Berkshire (GB)

(21) Appl. No.: 15/027,212

(22) PCT Filed: Oct. 6, 2014
(86) PCT No.: PCT/GB2014/053008

§ 371 Date: Apr. 4, 2016

(30) Foreign Application Priority Data
Oct. 4, 2013 (GB) 1317631.8

(51) Int. Cl. H04W 36/30; H04W 36/14; H04W 36/00

(52) U.S. Cl. CPC H04W 36/30; H04W 36/0072; H04W 36/14; H04W 84/12

(57) ABSTRACT

The present disclosure relates to methods and apparatuses for radio access technology (RAT) management for user terminals with a connection on at least one RAT. There is disclosed a method for controlling a selection of a RAT for traffic flow of a user terminal comprising the steps of receiving information on a user plane of a serving RAT; using the received information to determine a characteristic indicative of an expected quality for a connection between the user terminal and a candidate cell of a candidate RAT; comparing the user terminal's connection quality on a serving cell of the serving RAT to the characteristic indicative of the expected quality for a connection between the user terminal and the candidate cell of the candidate RAT; and determining on the basis of the comparison whether the user terminal should change its traffic flow to the candidate cell of the candidate RAT or maintain its traffic flow on the serving cell of the serving RAT.

### TECHNICAL FIELD

The present disclosure relates to radio access technology (RAT) management for user terminals with a connection on at least one RAT.

### BACKGROUND

There is a significant demand for data connections to user equipment (UE), for example smart phones, for purposes such as internet access on the UE. This has increased pressure on mobile network operators to satisfy data traffic demands.

Mobile networks may try to satisfy this demand by increasing their network capacity by increasing the amount of licenced spectrum that they utilise in their networks, for example by introducing new access technologies such as 3GPP LTE using new or existing licensed spectrum. However, the use of licenced spectrum can be costly.

Alongside cellar access to data services, such as the internet, UEs may also establish data connections using different access technologies, such as WLAN (Wireless Local Area Network, e.g. based on Wi-Fi™ certification). The popularity of using WLAN as an RAT for UEs, particularly smart phones, is increasing and in many cases is regarded by consumers to be a cheap alternative for access to the internet. The use of WLAN as an RAT for UEs is at this time relatively low cost because of its utilisation of free unlicensed spectrum, for example in the 2.4 GHz and 5 GHz bands, compared with the expensive licenced spectrum for cellular access.

Offloading UE data traffic onto WLAN networks may be attractive in order to relieve the pressure and cost of data transfer using cellular access. However, at this time, mobile network operators have little or no control over the Quality of Service (QoS) that their customers will get on a WLAN network when traffic is offloaded from the cellular network to the WLAN network. After a UE has connected to a WLAN network, it may transpire that there are already a large number of connected terminals all contending for access, or the WLAN access point may have a broken backhaul link resulting in the user not getting any service on the WLAN network.

When a UE leaves a cellular network providing good cellular connection, or switches traffic flow from cellular, to go to a WLAN with a poor data connection quality or no connectivity at all, there is a major impact on the user experience. This may be a particular problem when the switch from cellar access to WLAN access takes place automatically, i.e. without user intervention.

A UE may be configured to have a connection manager which considers signal strength measurements from cells of different access technologies, for example 3G, LTE and WLAN, and determines whether it should change RAT. For example, it may detect the presence of a WLAN ‘cell’ and automatically switch traffic to the WLAN network on the basis of signal strength measurement. However, a good signal strength is not in itself a guarantee of the data connection quality of the WLAN network and may result in switching traffic to a WLAN network with poor data connection quality.

A UE operating on cellular RAT may obtain information about the Basis Service Set (BSS) load and information on the backhaul of a WLAN network using Passpoint™ capabilities developed by the Wi-Fi™ alliance. On the basis of this information, the UE may assess whether the target WLAN network will provide a good data connection and determine whether it should switch its data traffic from cellular to WLAN. However, the WLAN network must configure some of the information, for example backhaul capability, on all access points (AP) to the WLAN or the WLAN networks must autonomously track the BBS load and backhaul load conditions and make those available to UEs on request. Moreover, the terminal must also be configured to support Passpoint capabilities in order to get the required information from the WLAN network.

A UE that is operating on a WLAN network has no means by which it may obtain information regarding how loaded a target cellular network is. Therefore, all a UE can do is make a default switch of traffic back to the cellular network when the WLAN does not itself provide an adequate service, which will not always lead to an improved experience for the user, for example when the cellular network is even worse than the WLAN network. In fact, a UE switching traffic back to a loaded cellular network might degrade the user experience for customers (UEs) already being served on the cellular network.

Solutions to this problem are being considered in 3GPP to allow the broadcast of a load indication from a cellular network, which would enable the UE to acquire the load indication and make an RAT selection on that basis. However, the broadcast of cellular network loading may not always be desirable for mobile network operators as it may reveal sensitive information about their network.

An alternative approach may be for the UE to maintain the cellular data signalling connection when it switches the data traffic to a WLAN network and use the cellular signalling connection to get information from the cellular network about its loading conditions. The UE may also use the cellular signalling connection to send information about the WLAN data connection quality to the cellular network. In this way, the cellular network may make a decision regarding the best RAT for the UE to select on the basis of the received information regarding the WLAN data connectivity and the cellular network's own knowledge of the status of the cellular network. However, this alternative approach would require 3GPP specification changes to the radio resource control (RRC) signalling, which have not yet been implemented.

A further approach being developed in 3GPP is to define network policies as part of the Access Network Discovery and Selection Function (ANDSF) framework to control RAT selection by the UE. For example, the UE may be provided with thresholds on minimum data connection quality or maximum loading of the different access technologies that the UE may use when considering switching RAT from the one currently selected. However, the policies that can be defined by the network are restricted by the information that a UE can acquire regarding the status of a WLAN network and cellular network. There are currently no means for a cellular network to indicate its loading status to a UE, so the UE cannot properly implement the network policies, even if provided.

When a UE is connected on a WLAN network, it can measure the connection quality by doing a ‘ping’, i.e. downloading/uploading some dummy data. This enables a UE with a data connection on a WLAN network to determine if the connection is good enough to stay on the WLAN network or if it should leave the WLAN network. However, the UE will still not know the data connection quality on the cellular RAT whilst it is connected to WLAN, unless the UE does a ping on the cellular network to obtain information regarding the cellular network connection quality. However, this approach may be costly for the cellular network in terms of the dummy data (non-chargeable traffic) that needs to be sent for each ping (the amount of dummy data required would typically be quite large in order correctly to assess the connection quality).

US20100234042 A1 describes an approach for interworking between radio access networks (RANs) that utilise different access technologies. The disclosure provides a RAN selector that may determine, upon initiation by a user terminal or a network, which RAN the user terminal should utilise. The selector may obtain information from at least one load information repository and perform load-balancing between different RANs. However, the user terminal uses an RAT specific modem to communicate with the related RAN using RAT specific signal (control plane signalling). Therefore, only limited functionality can be provided as a result of standards requirements on the control plane, which may impact on the quality of service achieved.

US20130121145 A1 describes carrying out network selection based on one or more factors. Network selection is carried out by a user device, wherein various factors, for example network congestion levels, are obtained directly from the access network, using RAT specific signalling. Therefore, only limited functionality can be provided as a result of standards requirements on the control plane, which may impact the effectiveness of the load distribution function. Crucially, there is no standardised method to exchange network congestion levels between cellular type networks, for example, 3G/LTE, and non-cellular type networks, for example, WLAN, which makes effective load balancing operations between cellular type networks and non-cellular type networks difficult.

### SUMMARY

The present disclosure provides a switching selector configured to control a selection of a radio access technology (RAT) for traffic flow (i.e. user data traffic) of a user terminal (user equipment UE) between a serving RAT and a candidate RAT, wherein the switching selector comprises: a status module configured to determine a characteristic indicative of an expected quality for a connection between the UE and a candidate cell of the candidate RAT using information received on a user plane (e.g. a data link layer, for example using at least one IP packet) of a connection on the serving RAT; and a comparison module configured to determine whether the user terminal should change its traffic flow on the candidate cell of the candidate RAT or maintain its traffic flow on a serving cell of the serving RAT on the basis of a comparison between the user terminal's connection quality on the serving cell of the serving RAT and the characteristic indicative of an expected quality for a connection between the UE and the candidate cell of the candidate RAT.

The load status module and the comparison module may be implemented by a single part, or module, of the switching selector, or as separate parts, or modules of the switching selector.

If it is determined that the user terminal should change its traffic flow to the candidate cell, the user terminal may switch its entire connection over to the candidate cell, such that no form of connection on the serving cell remains. Thus, the connection to the candidate cell may comprise a signalling connection and a user plane bearer for the user data traffic flow generated passing to and/or from the UE (for example, to and/or from an application on the UE). Alternatively, the user terminal may maintain a connection on the serving cell to maintain a signalling connection on the serving cell, and establish on the candidate cell a connection comprising a signalling connection and a user plane bearer for user data traffic flow.

By receiving information on the user plane (e.g. a data link layer for user data), using which a load status of the candidate cell of the candidate RAT can be determined, the switching selector can determine whether or not it would be beneficial for the user terminal to switch its traffic flow to a different RAT. Because the information is received on the user plane, this may take place in the same way regardless of what the current serving RAT is, or what the candidate RAT is. A network operator may straightforwardly exercise control over the protocol of transmissions on the user plane, so recourse to standards committees and groups is not required. Thus, without making any changes to the agreed standards of the control plane of any RAT, or anything else, or having to modify the transmitted information in any way to take into account what the serving or candidate RAT is, quality of service can be maintained and the user experience improved by only switching traffic flow to the candidate RAT when the expected quality that would be available through the candidate cell of the candidate RAT has been determined to be preferable to that of the serving RAT.

The ‘cell’ of a RAT is the coverage area of a transmitter/receiver (an access point) in the Radio AA Network of the RAT. The RAT may be a ‘cellular’ technology, such as UTMS or LTE, or a ‘non-cellular’ technology, such as WLAN or WiMAX, or any other form of data transporting RAT. Thus, the ‘cell’ might alternatively be known as a macrocell, a femtocell, a picocell, a hot-spot etc.

The comparison may take the form of an algorithm that is designed to compare the connection quality of the serving RAT with the characteristic indicative of the expected quality for a connection between the UE and the candidate cell of the candidate RAT and output a decision that the serving RAT should be used, or that the candidate RAT should be used.

When the switching selector forms part of the user terminal itself, for example as a client on the user terminal, the information used to determine the characteristic indicative of the expected quality for a connection between the UE and the candidate cell of the candidate RAT may be at least one indicator of the load status of the candidate cell of the candidate RAT and/or a measure relevant to the expected quality for a connection between the UE and the candidate cell of the candidate RAT. The at least one indicator of the load status of the candidate cell enables the determination to consider the loading of the candidate cell and consequently the likely level of data service that the user terminal might expect to receive from the candidate cell. The measure relevant to the expected quality for a connection enables the determination to consider the likely quality of connection (i.e., received signal strength, etc) that might be established between the user terminal and the candidate cell.

In order to obtain the at least one indicator of the load status of the candidate cell, the load status module is preferably further configured to cause a transmission, on the user plane of the serving RAT, from the user terminal to a candidate RAT load server, of a request for at least one indicator of the load status of the candidate cell of the candidate RAT when it is determined that the user terminal is within the candidate cell of the candidate RAT, wherein the request comprises an identifier of the candidate cell of the candidate RAT.

The switching selector may determine that the user terminal is within the candidate cell of the candidate RAT when it can ‘see’ a RAT (which is not the serving RAT) using which it may potentially route its traffic flow. For example, the user terminal may have detected a beacon of a candidate RAT. Again, by communicating on the user plane of the serving RAT, the protocols used in the communications do not need to change regardless of the serving RAT and nor do they need to adhere to any standards protocols defined for the ‘control plane’ of the serving RAT. Thus, determination of whether or not to switch access technology may work across multiple RATs and be independent of any RAT control plane.

The measure relevant to the expected quality for a connection between the user terminal and the candidate cell may be determined using at least one measurement relevant to a candidate cell signal strength at the user terminal. For example, it may be a measure of radio conditions for the candidate cell, wherein the radio conditions may include, for example, a signal strength of the candidate cell and/or interference conditions at the user terminal, such as signal to noise ratio. The at least one measurement(s) may be performed by the user terminal, for example using an appropriate API to a modem on the user terminal, for by any other suitable means.

Consideration of both the at least one indicator of load status of the candidate cell and the measure relevant to the expected quality of connection may improve the quality of the determination made by the determination module as it takes into account both the level of service that the candidate cell may be able to provide as well as the likely quality of connection that the user terminal might expect on the candidate cell of the candidate RAT.

When the switching selector forms part of a network server that is part of a network, for example when its functionality is implemented on a standalone server, such as a ‘switching server’, or as part of any other element in a network, for example in software or hardware of an existing network element, the information received may be an identifier of the candidate cell, which the user terminal has transmitted to the network server. Additionally, or alternatively, the information received may be a measure relevant to the expected quality for a connection between the user terminal and the candidate cell of the candidate RAT.

The network server may use the received identifier of the candidate cell to obtain from a candidate RAT load server at least one indicator of the load status of the candidate cell of the candidate RAT using the identifier of the candidate cell and determine the characteristic indicative of an expected quality for a connection between the UE and a candidate cell of the candidate RAT using the at least one indicator of the load status of the candidate cell of the candidate RAT.

Additionally, or alternatively, the network server may use the measure relevant to the expected quality for a connection between the user terminal and the candidate cell of the candidate RAT to determine the characteristic indicative of an expected quality for a connection between the UE and a candidate cell of the candidate RAT. The measure may comprise at least one measurement of at least one parameter relevant to the expected quality for a connection between the user terminal and the candidate cell of the candidate RAT. The at least one measurement may be performed by the user terminal and transmitted to the network server on the user plane of the serving RAT.

The at least one measurement of at least one parameter relevant to the expected quality for a connection between the user terminal and the candidate cell of the candidate RAT may comprise, for example, at least one measurement of a received signal strength of the candidate cell and/or at least one measurement of interference conditions at the user terminal, such as signal to noise ratio.

Consideration of both the at least one indicator of load status of the candidate cell and the measure relevant to the expected quality of connection may improve the quality of the determination made by the determination module as it takes into account both the level of service that the candidate cell may be able to provide as well as the likely quality of connection that the user terminal might expect on the candidate cell of the candidate RAT.

The at least one indicator of the load status of the candidate cell may be the air interface resource usage on uplink and/or downlink, the number of connected UEs on the candidate cell, the resource utilisation for the candidate cell, information on whether the backhaul of the candidate cell is down, or any other information or measurement using which the load status of the candidate cell may be determined.

The switching selector preferably further comprises: a connection status module configured to determine the user terminal's connection quality on the serving cell of the serving RAT using one or more of: at least one indicator of the load status of the serving cell of the serving RAT received from a serving RAT load server and/or at least one measurement performed by the user terminal of at least one parameter relevant to the user terminal's connection quality on the serving cell of the serving RAT.

When the switching selector forms part of the user terminal, the user terminal is preferably configured such that the at least one indicator of the load status of the serving cell of the serving RAT is received on the user plane of the serving RAT from the serving RAT load server in response to a request for the at least one indicator of the load status of the serving cell of the serving RAT sent by the connection status module on the user plane of the serving RAT; and/or the connection status module is further configured to perform at least one measurement of at least one parameter relevant to the user terminal's connection quality on the serving cell of the serving RAT.

By communicating on the user plane, the switching selector may more easily obtain the information it requires to determine the status of the user terminal's connection on the serving cell, as explained earlier.

When the switching selector forms part of a network server, the switching selector is preferably further configured such the connection status module is further configured to obtain from a serving RAT load server at least one indicator of the load status of the serving cell of the serving RAT using an identifier of the serving cell received on the user plane of the serving RAT from the user terminal; and/or the connection status module is further configured receive from the user terminal on the user plane of the serving RAT the measure relevant to the user terminal's connection on the serving cell of the serving RAT. Again, the above described advantages of using the user plane to transfer this information makes it easier for the switching selector to obtain the information it requires to determine whether or not the user terminal should switch RAT.

The measure relevant to the user terminal's connection quality on the serving cell may comprise at least one measurement of an achieved throughput for user data and/or at least one measurement of at least one ping performed by the user terminal and/or radio conditions of the serving RAT, which may include, for example, a received signal strength of the serving cell and/or interference conditions at the user terminal, such as signal to noise ratio.

The quality of the user terminal's connection on the serving cell may therefore be determined by the switching selector, whether the switching selector forms part of the user terminal or a network server, from at least one indicator of the load status of the serving cell and/or at least one measurement of at least one parameter relevant to the user terminal's connection on the serving cell.

As explained earlier, when the switching server forms part of a network server, it is preferably configured to receive information from the user terminal on the user plane of the user terminal's connection on the serving RAT. For example, the received information may be an identifier of the candidate cell and/or an identifier of the serving cell and/or a measurement of at least one parameter relevant to the connection on the serving cell and/or a measurement of a least one parameter relevant to an expected quality for a connection between the user terminal and the candidate cell. The switching selector may also be configured to receive the IP address of the user terminal, which the switching selector may later use for sending information back to the user terminal.

In some instances, the switching selector may act in response to instructions sent from the user terminal. For example, the user terminal may determine that it would like a switching assessment to be made and transmit the user terminal's IP address; and/or information for determining a characteristic indicative of an expected quality for a connection between the UE and a candidate cell (i.e. a candidate cell identifier and/or a measure relevant to the expected quality of connection); and/or a serving cell identifier and/or at least one measurement relating to the connection quality on the serving RAT.

In other instances, the switching selector may instigate a switching assessment itself. In this case the switching selector may further comprise a request module configured to cause a transmission, on the user plane of the connection on the serving RAT, from the network server to the user terminal of a request for the identifier of the candidate cell of the candidate RAT and/or the measure relevant to an expected quality of connection between the user terminal and the candidate cell. The request module may also, or alternatively, be configured to cause a transmission, on the user plane of the connection on the serving RAT, from the network server to the user terminal of at least one of a request for an identifier of the serving cell of the serving RAT; and/or a request for at least one measurement of at least one parameter relevant to the user terminal's connection quality on the serving cell of the serving RAT. Thus, by communicating with the user terminal on the user plane of the connection on the serving RAT, the switching selector may more easily obtain the information it requires from the user terminal regardless of the RAT serving the user terminal.

When the switching selector forms part of the network server, it may be further configured to comprise: an instruction module configured to cause a transmission from the network server to the user terminal, on the user plane of the connection on the serving RAT, of an instruction for the user terminal to change its traffic flow to the candidate cell of the candidate RAT when the comparison module has determined that the user terminal should change its traffic flow to the candidate cell of the candidate RAT.

In this way, if the switching selector determines that the user terminal should switch the RAT used for its traffic flow, it may easily use the serving RAT to instruct the user terminal accordingly, in response to which the user terminal may utilise its operating system (OS) to execute the change.

The switching selector forming part of a network server may also be configured to exercise global control over user terminal access technologies. In this way, it may determine whether or not one of more user terminals should switch their RAT not only on the basis of the potential quality traffic flow on the candidate cell for each user terminal, but also the current and alternative access technologies available to other user terminals in the same area and the status of the various cells of different access technologies in the same area. Thus, in addition to improving the user experience for user terminals, the switching selector may also exercise load balancing for one or more different access technologies across one or more cells of each different RAT.

To this end, the comparison module of the switching selector may be further configured to determine whether the user terminal should change its traffic flow to the candidate cell of the candidate RAT or maintain its traffic flow on the serving cell of the serving RAT also on the basis of at least one of: an indication of a received signal strength of the candidate RAT at the user terminal, wherein the indication is received by the comparison module from the user terminal on the user plane of the connection of the serving RAT; and an indication of a received signal strength of the serving RAT at the user terminal, wherein the indication is received by the comparison module from the user terminal on the user plane of the connection of the serving RAT. This information may be transmitted from the user terminal to the network server of the user terminal's own volition (for example, when the user terminal itself is instigating a switching assessment), or in response to a request transmitted by the network server on the user plane of the user terminal's serving RAT.

As part of its global assessment abilities, the comparison module of the switching selector may be further configured to determine whether the user terminal should change its traffic flow to the candidate cell of the candidate RAT or maintain its traffic flow on the serving cell of the serving RAT also on the basis of at least one of: the number of user terminals within coverage of the serving cell of the serving RAT; the number of user terminals within coverage of the serving cell of the serving RAT that are also within a coverage of at least one cell of the candidate RAT; a received signal strength of the serving RAT at the user terminal; a received signal strength of the serving RAT at other user terminals within a coverage of the serving cell of the current RAT; a received signal strength of the candidate cell of the candidate RAT at the user terminal; a received signal strength of any cells of the candidate RAT at any other user terminals within a coverage of the candidate cell of the candidate RAT; and a load status of any cells of the candidate RAT that are within the coverage of the serving cell of the serving RAT.

In a further aspect of the present disclosure, there is provided a load server configured to receive information from a user terminal on a user plane of the user terminal's connection on a serving radio access technology (RAT) and to cause the transmission of information from the load server to the user terminal on the user plane of the user terminal's connection on the serving RAT, wherein the load server comprises: a load status indicator module configured to identify at least one indicator of a load status of a cell of an RAT in response to a request received from the user terminal on the user plane of the user terminals' connection on the serving RAT; and a response module configured to cause a transmission to the user terminal, on the user plane of the user terminal's connection on the serving RAT, of the requested at least one indicator of the load status of the cell of the RAT.

The load server may thus interact with a switching selector formed on a user terminal. In this way, the switching selector may obtain any indicators of load status of a cell (the candidate cell and/or the serving cell) that it requires in order to assess whether or not to switch RAT.

In a further aspect of the present disclosure, there is provided a method for controlling a selection of a radio access technology (RAT) for traffic flow of a user terminal, the method comprising the steps of: receiving information on a user plane (i.e. a data link layer for user data) of a serving RAT; using the received information to determine a characteristic indicative of an expected quality for a connection between the user terminal and a candidate cell of a candidate RAT; comparing the user terminal's connection quality on a serving cell of the serving RAT to the characteristic indicative of the expected quality for a connection between the UE and the candidate cell of the candidate RAT; and determining on the basis of the comparison whether the user terminal should change its traffic flow to the candidate cell of the candidate RAT or maintain its traffic flow on the serving cell of the serving RAT.

These steps may be performed by an element, for example the switching selector, implemented either on a network server or on the user terminal, as explained above. Thus, a more reliable assessment of whether or not the user terminal should switch RAT may be made, without requiring any changes to be made by standards groups to control plane protocols and without any consideration to what RAT is currently serving the user terminal. As a result, quality of service of the user terminal's connection may be more assured and potential traffic flow improvements by switching access technologies realised.

In a further aspect of the present disclosure, there is also provided a switching controller implemented on a user terminal with a connection on a serving RAT, wherein the switching controller comprises: an switching module configured to cause the user terminal to switch its traffic flow to a candidate cell on a candidate RAT in response to an instruction received on a user plane of the user terminal's connection on the serving RAT. The switching controller may be implemented as a client or part of a client on the user terminal, or any other suitable element of the user terminal. Thus, when the switching selector described above forms part of a network server, the switching selector may utilise the user plane (i.e. a connection used to deliver data) of the serving RAT to instruct the switching controller on the user terminal to effect a switch of the traffic flow to the candidate RAT. Thus, the user experience of the user terminal may be improved by switching RAT only when a proper assessment has been made by the switching selector.

The switching module on the switching controller may be further configured to transmit to a switching selector formed on a network server an identifier of the candidate cell of the candidate RAT, on the user plane of the connection on the serving RAT. This may be in response to an instruction from the switching selector, or of the switching module's own volition (for example, when it determines that it is within a candidate cell and would like a switching assessment to be made by the switching selector).

Furthermore the switching controller may further comprise: a measurement module configured to perform at least one measurement of at least one parameter relevant to the user terminal's connection quality on the serving cell of the serving RAT and/or at least one measurement of at least one parameter relevant to the expected quality for a connection between the user terminal and the candidate cell, and transmit to a switching selector formed on a server, on the user plane of the connection on the serving RAT, the at least one measurement. Again, this may be in response to an instruction from the switching selector, or of the switching controller's own volition (for example, when it determines that it would like a switching assessment to be made by the switching selector).

Furthermore, the switching module on the switching controller may be further configured transmit to a switching selector formed on a network server an identifier of a serving cell of the serving RAT, on the user plane of the connection on the serving RAT. Again this may be in response to an instruction from the switching selector, or of the switching controller's own volition (for example, when it determines that it would like a switching assessment to be made by the switching selector).

In all of the aspects of the disclosure, the functionality of one or more of the modules described above may be implemented by a single part, or module, of the switching selector, or as separate parts, or modules, of the switching selector.

Further aspects of the present disclosure are set out in the following numbered clauses:

1. A switching selector configured to control a selection of a radio access technology (RAT) for traffic flow of a user terminal between a serving RAT and a candidate RAT, wherein the switching selector comprises:
a load status module configured to determine a load status of a candidate cell of the candidate RAT using information received on a user plane of a connection on the serving RAT; and
a comparison module configured to determine whether the user terminal should change its traffic flow on the candidate cell of the candidate RAT or maintain its traffic flow on a serving cell of the serving RAT on the basis of a comparison between the user terminal's connection quality on the serving cell of the serving RAT and the load status to the candidate cell of the candidate RAT.

2. The switching selector of clause 1, wherein the load status module of the switching selector is further configured to:
determine the load status of the candidate cell of the candidate RAT from at least one indicator of the load status of the candidate cell of the candidate RAT received from a candidate RAT load server.

3. The switching selector of either clause 1 or clause 2, further comprising:
a connection status module configured to determine the user terminal's connection quality on the serving cell of the serving RAT using one or more of:
   at least one indicator of the load status of the serving cell of the serving RAT received from a serving RAT load server; and.
   at least one measurement performed by the user terminal of at least one parameter relevant to the user terminal's connection quality on the serving cell of the serving RAT.

4. The switching selector of clause 3, wherein the switching selector forms part of the user terminal, and wherein:
the at least one indicator of the load status of the serving cell of the serving RAT is received on the user plane of the serving RAT from the serving RAT load server in response to a request for the at least one indicator of the load status of the serving cell of the serving RAT sent by the connection status module on the user plane of the serving RAT; and/or
the connection status module is further configured to perform at least one measurement of at least one parameter relevant to the user terminal's connection quality on the serving cell of the serving RAT.

5. The switching selector of clause 3, wherein the switching selector forms part of a network server, and wherein:
the connection status module is further configured to obtain from a serving RAT load server at least one indicator of the load status of the serving cell of the serving RAT using an identifier of the serving cell received on the user plane of the serving RAT from the user terminal; and /or.
the connection status module is further configured receive from the user terminal on the user plane of the serving RAT at least one measurement of at least one parameter relevant to the user terminal's connection on the serving cell of the serving RAT.

6. The switching selector of any one of clauses 1 to 4, wherein the switching selector forms part of the user terminal and the information used to determine a load status of a candidate cell of the candidate RAT is at least one indicator of the load status of the candidate cell of the candidate RAT, and wherein

the load status module is further configured to cause a transmission, on the user plane of the serving RAT, from the user terminal to a candidate RAT load server of a request for at least one indicator of the load status of the candidate cell of the candidate RAT when it is determined that the user terminal is within the candidate cell of the candidate RAT, wherein the request comprises an identifier of the candidate cell of the candidate RAT.

7. The switching selector of any one of clauses 1 to 4 or 6, wherein the switching selector forms part of a network server, and the information used to determine the load status of the candidate cell of the candidate RAT is an identifier of the candidate cell of the candidate RAT, wherein
the load status module is further configured to obtain from a candidate RAT load server at least one indicator of the load status of the candidate cell of the candidate RAT using an identifier of the candidate cell and determine the load status of the candidate cell of the candidate RAT using the at least one indicator of the load status of the candidate cell of the candidate RAT.

8. The switching selector of clause 7, wherein the switching selector further comprises:
a request module configured to cause a transmission, on the user plane of the connection on the serving RAT, from the server to the user terminal of a request for the identifier of the candidate cell of the candidate RAT.

9. The switching selector of either clause 7 or clause 8, wherein the switching selector further comprises:
a request module configured to cause a transmission, on the user plane of the connection on the serving RAT, from the network server to the user terminal of at least one of:
   a request for an identifier of the serving cell of the serving RAT; and
   a request for at least one measurement of at least one parameter relevant to the user terminal's connection quality on the serving cell of the serving RAT.

10. The switching selector of any one of clauses 7 to 9, further comprising:
an instruction module configured to cause a transmission from the network server to the user terminal, on the user plane of the connection on the serving RAT, of an instruction for the user terminal to change its traffic flow to the candidate cell of the candidate RAT when the comparison module has determined that the user terminal should change its traffic flow to the candidate cell of the candidate RAT.

11. The switching selector of any one of clauses 7 to 10, wherein:
the comparison module is further configured to determine whether the user terminal should change its traffic flow to the candidate cell of the candidate RAT or maintain its traffic flow on the serving cell of the serving RAT also on the basis of:
   an indication of a received signal strength of the candidate RAT at the user terminal, wherein the indication is received by the comparison module from the user terminal on the user plane of the connection of the serving RAT;

12. The switching selector of clause 11, wherein the switching selector further comprises
a request module configured to cause a transmission, on the user plane of the connection on the serving RAT, from the network server to the user terminal of a request for at least one of:
   the indication of the received signal strength of the candidate RAT at the user terminal; and
   the indication of the received signal strength of the serving RAT at the user terminal.

13. The switching selector of any one of clauses 7 to 10, wherein the comparison module is further configured to determine whether the user terminal should change its traffic flow to the candidate cell of the candidate RAT or maintain its traffic flow on the serving cell of the serving RAT also on the basis of at least one of:
the number of user terminals within coverage of the serving cell of the serving RAT;
the number of user terminals within coverage of the serving cell of the serving RAT that are also within a coverage of at least one cell of the candidate RAT;
a received signal strength of the serving RAT at the user terminal;
a received signal strength of the serving RAT at other user terminals within a coverage of the serving cell of the current RAT;
a received signal strength of the candidate cell of the candidate RAT at the user terminal;
a received signal strength of any cells of the candidate RAT at any other user terminals within a coverage of the candidate cell of the candidate RAT; and
a load status of any cells of the candidate RAT that are within the coverage of the serving cell of the serving RAT.

14. A load server configured to receive information from a user terminal on a user plane of the user terminal's connection on a serving radio access technology (RAT) and to cause the transmission of information from the load server to the user terminal on the user plane of the user terminal's connection on the serving RAT, wherein the load server comprises:
a load status indicator module configured to identify at least one indicator of a load status of a cell of an RAT in response to a request received from the user terminal on the user plane of the user terminals' connection on the serving RAT; and
a response module configured to cause a transmission to the user terminal, on the user plane of the user terminal's connection on the serving RAT, of the requested at least one indicator of the load status of the cell of the RAT.

15. A method for controlling a selection of a radio access technology (RAT) for traffic flow of a user terminal, the method comprising the steps of:
receiving information on a user plane of a serving RAT;
using the received information to determine a load status of a candidate cell of a candidate RAT;
comparing the user terminal's connection quality on a serving cell of the serving RAT to the load status of the candidate cell of the candidate RAT; and
determining on the basis of the comparison whether the user terminal should change its traffic flow to the candidate cell of the candidate RAT or maintain its traffic flow on the serving cell of the serving RAT.

### BRIEF DESCRIPTION OF THE DRAWINGS

Aspects of the present disclosure shall now be described, by way of example only, with reference to the following drawings, in which:

FIGS. 1(a), 1(b) and 1(c) shows a representation of a load server located in radio access networks of different access technologies;

FIG. 2 shows a representation of a system comprising a user equipment (UE) and two load servers of the type represented in FIGS. 1(a), 1(b) and 1(c);

FIG. 3 shows a representation of a system comprising a user equipment (UE), a switching server and two load servers of the type represented in FIGS. 1(a), 1(b) and 1 (c); and

FIG. 4 shows a representation of a system comprising a first user equipment (UE), a second UE, a switching server and two load servers of the type represented in FIGS. 1(a), 1(b) and 1(c).

### DETAILED DESCRIPTION

In network data communications on a radio communications network (for example, UTMS or LTE), a connection to a user equipment (UE), such as a smartphone, tablet or computer, may be considered to comprise at least two parts or planes: the control plane (also known as the signalling plane) and the user plane (also known as the data plane or bearer plane).

The control plane utilises one or more dedicated control bearers/connections (for example, a Radio Resource Control (RCC) connection) for the transfer of control information using formats and protocols agreed by standards groups. Communications that do not conform to approved standards may not take place on the control plane.

The user plane utilises one or more dedicated data bearers/connections for the transfer of user data. It is a connection on which user data (e.g. traffic flow) is transmitted. User data (e.g. traffic flow) transmitted via the user plane does not need to conform to any formats or protocols agreed by standards groups, so network operators may implement their own formats or protocols for transmissions on the user plane.

In non-cellular data communications on a radio communications network (for example, Wi-Fi), a connection to a user equipment (UE) may comprise authentication of the UE on the network and the ability to send/receive data frames over Wi-Fi radio for user data (traffic flow), which may, for example, be generated by an application on the UE.

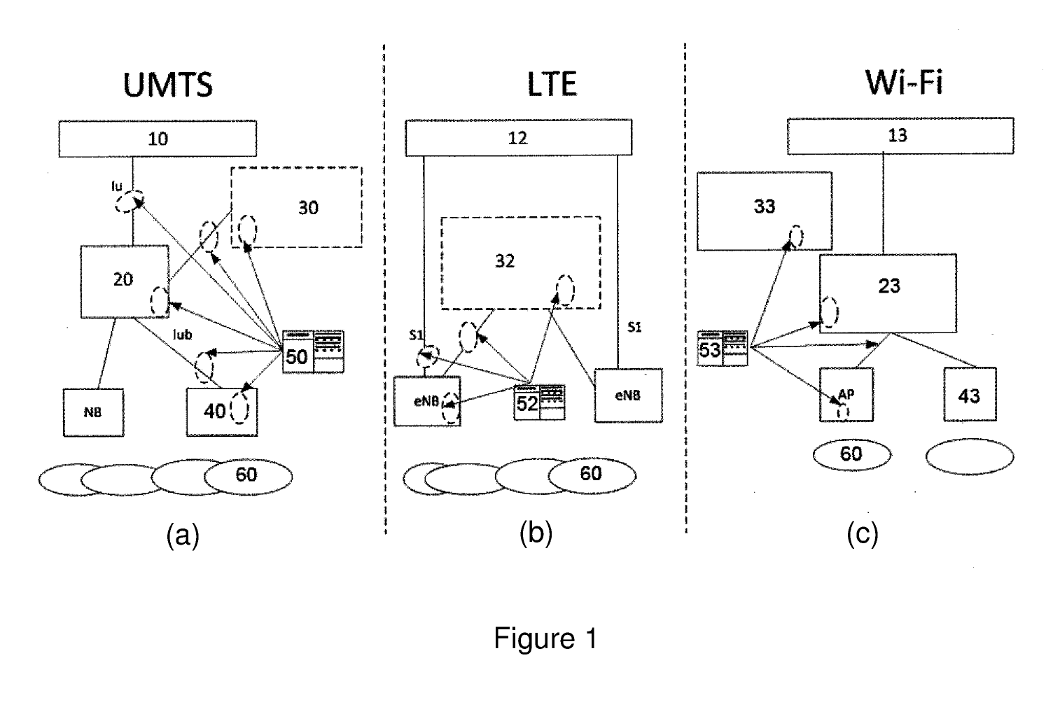

FIG. 1(a) shows an example of a cellular radio network providing UMTS (Universal Mobile Telecommunications System) radio access technology (RAT). The cellular radio network is connected to a core network 10 and comprises a radio network controller (RNC) 20, a network management system (O&M) 30, two node Bs (NB) 40, a load server 50 and cells 60. The core network 10 is in communication with the RNC 20 and the RNC 20 is also in communication with the O&M 30 and the two NBs 40.

The load server 50 is configured to gather near real time information on the load status of at least one cell of the cellular radio network. In order to do this, as shown in FIG. 1(a), the load server 50 may be connected to at least one of the communication channel between the core network 10 and the RNC 20; the RNC 20; the communication channel between the RNC 20 and the O&M 30; the O&M 30; the communication channel between the RNC 20 and the NB 40; and the NB 40.

For example, the RNC 20 in a UTMS network may already be configured to monitor the load status of cells under its control and may relay that information to the O&M 30, in which case the load server 50 may obtain load status information directly from the RNC 20, or the O&M 30, or from the communication channel between the RNC 20 and O&M 30.

The load server 50 stores load status information on a per cell basis, wherein the stored information is identified by a unique identity of the cell. Having gathered and stored load status information, the load server 50 may make load status information available to relevant parties. For example, a client on a UE may request load status information for a particular cell 60, or a server may request load status information for a particular cell, both of which scenarios are explained in more detail later. The load status information provided by the load server 50 may be averaged over a certain period of time, or may be an instantaneous indictor of load status.

FIG. 1(b) shows a representation of a cellular radio network providing a LTE (Long Term Evolution) RAT. The cellular radio network is similar to the cellular radio network 1 and is connected to a core network 12, an LTE Network Management system (O&M) 32, two evolved Node Bs (eNB) 42, a load server 52 and cells 60.

The load server 52 is configured to gather near real time information on the load status of at least one cell of the cellular radio network. In order to do this, as shown in FIG. 1(b), the load server 52 may be connected to at least one of the communication channel between the core network 10 and eNB 42; the O&M 32; the communication channel between the O&M 30 and eNB 42; and the eNB 42.

For example, the eNB 42 may be responsible for assessing the load of all cells under its control and relaying this information to the O&M 32, in which case the load server 52 may obtain load status information directly from the eNB 42, or from the O&M 32, or from the communication channel between the eNB 42 and O&M 32.

Just as with the load server 50, the load server 52 stores load status information on a per cell basis, wherein the stored information is identified by a unique identity of the cell and again, in the same way as load server 50, having gathered and stored load status information, the load server 52 may make load status information available to relevant parties.

FIG. 1(c) shows a representation of a cellular radio network providing WLAN (Wireless Local Area Network) RAT. The cellular radio network is connected to a core network 13 and comprises a WLAN controller 23, an access network query protocol (ANQP) server 33, two access points (AP) 43, a load server 53 and cells 60.

The load server 53 is configured to gather near real time information on the load status of at least one cell of the cellular radio network. In order to do this, as shown in FIG. 1(c), the load server 53 may be connected to at least one of the WLAN controller 23; the ANQP server 33; the AP 43; and the communication channel between the WLAN controller 23 and the AP 43.

For example, load status information may be collected by the WLAN controller 23, which manages a number of APs 43, in which case the load server 53 may obtain load status information directly from the WLAN controller 23.

Just as with the load server 50 and load server 53, the load server 53 stores load status information on a per cell basis, wherein the stored information is identified by a unique identity of the cell, for example a Medium Access Control (MAC) ID and/or SSID identifying the AP 43 in the network. Again, in the same way as load servers 50 and 52, having gathered and stored load status information, the load server 53 may make load status information available to relevant parties.

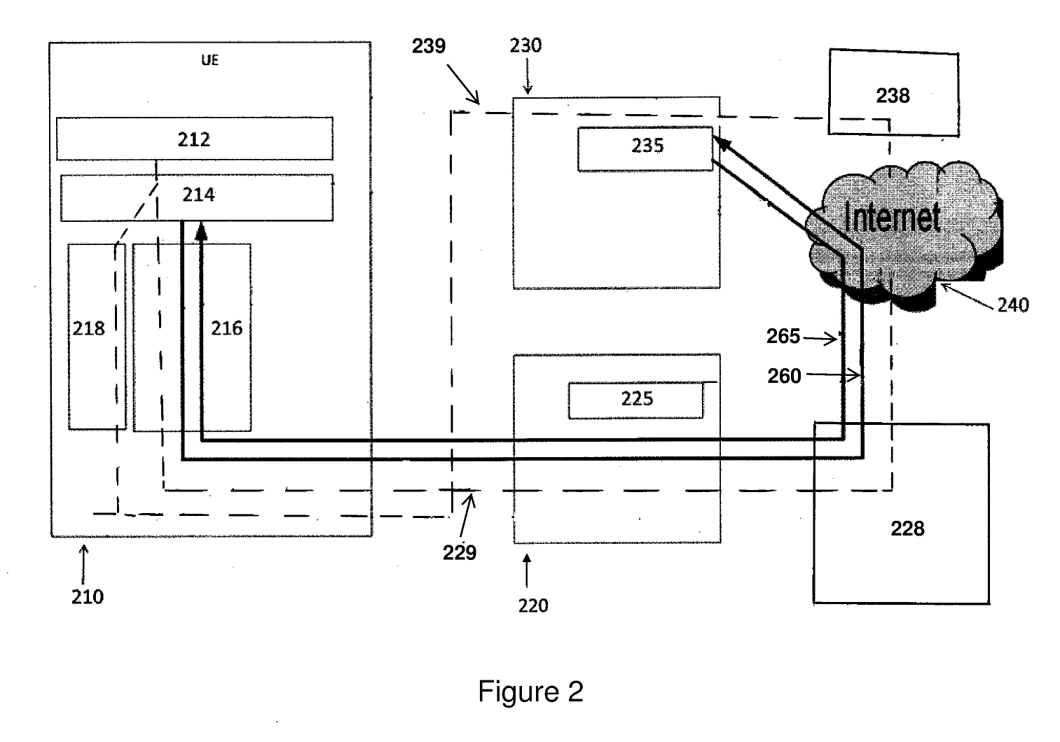

FIG. 2 shows an aspect of the present disclosure whereby a UE may utilise load status information obtained from a load server in order to exercise RAT management.

Represented in FIG. 2 is a UE 210 comprising an application 212 and a UE client 214. The UE 210 is within the coverage of a cell of radio access network (RAN) A 220 and utilises that cell (the serving cell) to make use of RAT A 216 (the current RAT) to provide connectivity for the UE 210, for example for the application 212. The path taken by information when the UE 210 is being served by RAN A 220 is shown by the dashed-line 229, which passes through RAN A 220, core network A 228 and the Internet 240. The path taken by information when the UE is being served by RAN B 230 is shown by the dashed line 239, which passes through RAN B 230, core network B 238 and the Internet 240.

The UE client 214 may determine that the UE 210 is in the coverage of a cell of RAN B 230 and may potentially therefore make use of RAT B 218 (the candidate RAT) to provide connectivity for the UE 210. The UE client 214 may, for example, sit above a modem, such as a WLAN or 3GPP modem, and may obtain information about the identity of the cell (the candidate cell) of RAN B 230 using an appropriate Application Programme Interface (API) to the modem provided by the operating system (OS) of the UE 210. With this information, the UE client 214 may use RAT A 216 to establish an IP connection 260 over the Internet 240 to a load server B 235 in the usual way (i.e. via RAN A 220, core network A 228 and the Internet 240). Load server B 235 monitors the load status of the identified cell of RAN B 230.

The UE client 214 may then send on the user plane of the IP connection 260 an IP packet to the load server B 235 comprising the UE's IP address allocated by the serving RAN A 220; an identifier of the candidate cell of RAN B 230; and a request for load status information of the candidate cell of the RAN B 230. The requested load status information may include at least one of the air interface resource usage on uplink and/or downlink, the number of connected UEs on the candidate cell, the resource utilisation on the backhaul for that cell and information on whether the backhaul is down.

The cell identifier may be any means by which the cell may be uniquely identified. For example, when the candidate RAT is WLAN, the identifier of the cell of the candidate RAN B 230 may comprise at least one of the AP MAC address for the cell and/or a network identifier, such as an SSID. The MAC address may be contained in the beacon frame that is broadcast by the AP. The UE 210 may evaluate the validity of a WLAN network (i.e. the SSID) based on its subscription policy and identify in the IP packet (using the MAC address and/or valid SSID(s)) only the cells networks that it has determined to be valid. When the candidate RAT is a cellular technology, such as UTMS or LTE, the identifier of the cell beacon may broadcast a unique ‘cell identity’ in system information, which is sufficient to uniquely identify the cell within an operator's network, which the UE 210 may then use as the identifier of the cell. The system information may also contain a globally unique identity of the cell which is a combination of the Public Land Mobile Network (PLMN) and cell identity.

The load server B 235 can analyse the received IP packet and use the cell identity to retrieve the requested load status information from its database. The load server B 235 can then encapsulate the relevant information into an IP packet and send it back to the UE client 214 on the user plane of an IP connection 265 (which is established on RAT A 216 by using the UE's 210 indicated IP address). Thus, the UE client 214 may receive the IP packet on the user plane of its connection on RATA 216.

The UE client 214 can analyse the received IP packet to get the load status information of the candidate cell in RAN B 230.

In order to determine whether or not it may be beneficial for the UE 210 to switch traffic flow from RAT A 216 to RAT B 218, the UE client 214 evaluates the connection quality of the serving cell of RAN A 230. The UE client 214 may do this by measuring an achieved throughput for user data on RAT A 216. Alternatively, or additionally, the UE client 214 may perform at least one ping to assess the connection quality. Alternatively, or additionally, the UE client 214 may measure the signal strength of a received signal strength from the serving cell of RAN A 230. For example, if RAN A 230 is an LTE network, this may be the reference signal received power (RSRP) for the serving LTE cell. If, for example, RAN A 230 is a UTMS network, this may be the received signal code power (RSCP) for the serving UTMS cell. Alternatively, or additionally, the UE client may measure interference conditions at the UE 210, for example the signal to noise ratio (SNR).

Alternatively, or additionally, the UE client 214 may obtain load status information from load server A 225, which resides in RAN A 220. This requires the UE client 214 to establish an IP connection on RAT A 216 to load server A 235 and transmit on the user plane of the IP connection a request for load status information of the serving cell of RAN A 220. The request for information will be analogous to that transmitted on IP connection 260 to the load server B 235 and may identify the IP address allocated to the UE 210 by the RAN A 220 (if this is necessary in order for the load server 225 later to return the requested information to the UE client 212); the identity of the serving cell (which the UE client 214 may obtain, for example, using the API to the UE 210 modem); and the nature of the load status information required.

The load server B 235 may then provide the UE client 214 with the requested load status information in an IP packet on the user plane of RAT A 216 via an IP connection between the load server B 235 and the UE 210.

In order to determine if the UE 210 should maintain its traffic flow on RAT A 216, or switch its traffic flow to RAT B 218, the UE client 214 runs an algorithm to compare the quality of connection it has on the serving cell of RAN A 220 with the load status information it has for the candidate cell of RAN B 230. As part of this determination, the UE client 214 may also consider the radio coverage status of the candidate cell, for example the signal strength of the candidate cell received at the UE 210 and/or interference conditions for the candidate cell at the UE 210 (i.e. SNR). Consideration of the radio coverage status may help to determine not only if the load status of the candidate cell of RAN B 230 is sufficiently promising to switch RATs, but also if the expected quality of connection to the candidate cell of RAN B 230 is sufficiently promising to switch RATS. The nature and details of the algorithm may depend on the type and quantity of load information being compared. The skilled person will appreciate that the algorithm may be any algorithm suitable for deciding whether or not to switch from a serving RAT to a candidate RAT on the basis of load status/connection quality information of the access technologies.

If the UE client 214 determines that the traffic flow should switch to RAT B 218, it may trigger the switch using the services of the operating system (OS) on the UE 210. Once the traffic flow is set up over RAT B 218, the traffic flow is routed over that connection by the UE 210. A signalling connection may still optionally be maintained on RAT A 216 for signalling data, even when the traffic flow has been switched to RAT B. For example, if RAT A is a cellular technology, such as UTMS or LTE, and RAT B is a non-cellular technology, such as WiFi, the UE 210 may switch its traffic flow to RAT B and still maintain an active signalling connection on RAT A. After switching to RAT B 218, the UE 210 can start to monitor a candidate cell of RAN A 220 and trigger a request via the user plane of the connection on RAT B 218 to the load server A 225 for load information of a candidate cell of RAN A 220. An analogous process to that described above can be used by the UE client 214 to determine whether or not the UE 210 should switch its traffic flow back to RAT A 216 (even if traffic flow switches back to RAT A 216, a signalling connection on RAT B 218 may still optionally be maintained for signalling data).

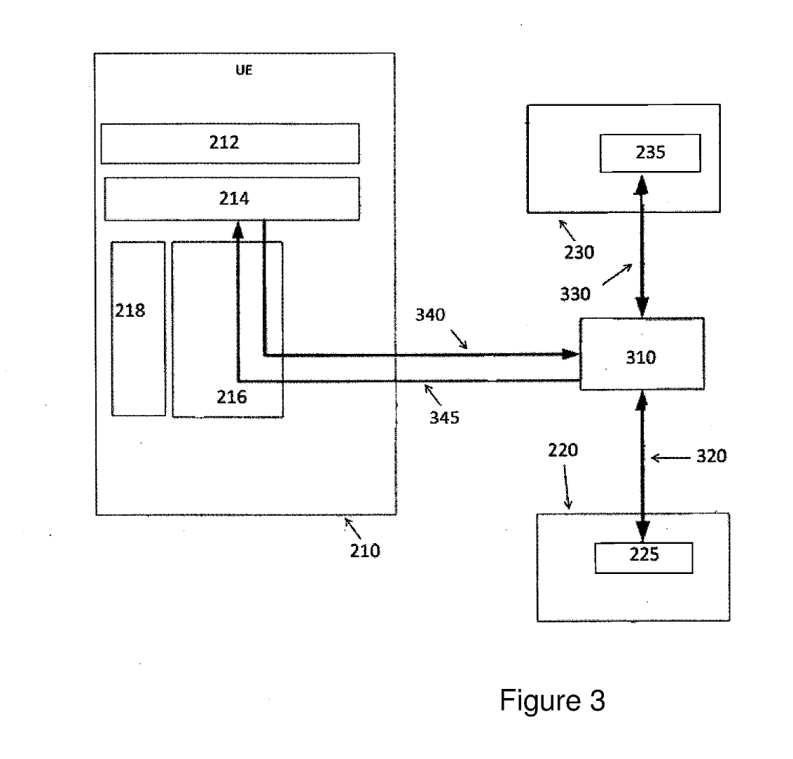

FIG. 3 shows a further aspect of the present disclosure whereby load status information is used to exercise RAT management. Whilst representations of the internet 240, core network A 228 and core network B 238 have been omitted from FIG. 3, and the IP connections 340, 345 are not shown to pass through RAN A 220, this is for the sake of clarity of the drawing only. It will be understood that IP connections between the UE 210 and load servers are formed via a serving RAN, corresponding core network and the internet in the same way as shown in FIG. 2 and described above.

The arrangement shown in FIG. 3 is similar to that of FIG. 2, but further comprises a switching server 310 that is configured to evaluate the best RAT available to the UE 210.

The UE 210 traffic flow is initially on RAT A 216. The UE client 214 may determine that the UE 210 is in the coverage of a cell (the candidate cell) of RAN B 230 and may potentially therefore make use of RAT B 218 (the candidate RAT) to provide connectivity for the UE 210.

Having determined that the UE 210 is in the coverage of a cell of RAN B 230, the UE client 214 sets up an IP connection 340 to the switching server 310 via RAT A 214. The IP address of the switching server 310 may be stored in addressing information within the UE client 214, and/or may be provisioned over the air at any time, so that the UE client 214 can set up the IP connection 340. The IP connection 340 is established to send on the user plane of IP connection 340 an IP packet comprising the UE's 210 IP address allocated by the serving RAN A 220; an identifier of the candidate cell of the candidate RAN B 230; and at least one of an identifier of the serving cell of RAN A 220 and/or a measurement of an indicator of connection quality on the serving cell of RAN A 220. The IP packet may also comprise at least one of a measure of the received signal strength of the candidate cell of the candidate RAN B 230 and/or interference conditions at the UE 210 for the signal from the candidate cell of the candidate RAN B 230 (for example, SNR).

The measurement of the connection quality on the serving cell of RAN A 220 may be a measurement performed by UE 210 of an achieved throughput for user data on RAT A 216. Alternatively, or additionally, it may be the results of at least one ping from the UE 210 to assess the connection quality. Alternatively, or additionally, it may be a measure of the signal strength of a received signal from the serving cell of RAN A 230. For example, if RAN A 230 is an LTE network, this may be the reference signal received power (RSRP) for the serving LTE cell. If, for example, RAN A 230 is a UTMS network, this may be the received signal code power (RSCP) for the serving UTMS cell. Alternatively, or additionally, it may be a measure of interference conditions at the UE 210, for example the signal to noise ratio (SNR).

The switching server 310 can analyse the received IP packet and use the candidate cell identifier to query the relevant load server, load server B 235, for the load status of the candidate cell of RAN B 230. For example, the requested information may include at least one of the air interface resource usage on uplink and/or downlink, the number of connected UEs on the candidate cell, the resource utilisation on the backhaul for the candidate cell and information on whether the backhaul is down etc. The load server B 235 may then use the cell identifier to look up the relevant information and return the requested information to the switching server 310.

In order to determine whether or not it may be beneficial for the UE 210 to switch traffic flow from RAT A 216 to RAT B 218, the switching server 310 evaluates the connection quality of the serving RAT A 216.

If the IP packet from the UE client 214 transmitted on IP connection 340 included the identity of the serving cell of RAN A 220, the switching server 310 may request load status information for the serving cell from load server A 225. Load server A 225 will use the identity of the serving cell to look up the relevant information and return the requested information to the switching server 310. That information may form at least part of the evaluation of the connection quality of the serving cell of RAT A 216.

Additionally, or alternatively, if the IP packet from the UE client 214 transmitted on IP connection 340 included at least one measurement of an indicator of connection quality, this may form at least part of the evaluation of the connection quality of the serving cell of RAT A 216.

In order to determine if the UE 210 should maintain its traffic flow on RAT A 216, or switch its traffic flow to RAT B 218, the switching server 310 runs an algorithm to compare the information it has for the serving cell of RAN A 220 (which may include measures of received signal strength and/or SNR, if these have been received from the UE 210) with the information it has for the candidate cell of RAN B 230. The algorithm may be similar to that described earlier in respect of the first aspect of the present disclosure.

If the switching server 310 determines that the UE's 210 traffic flow should switch to RAT B 218, it may utilise the IP address of the UE 210 to establish an IP connection 345 to the UE 210 on RAT A. The switching server 310 then sends an instruction on the user plane of the IP connection 345 to the UE client 214 to switch to RAT B 218, upon receipt of which the UE client 214 can trigger the switch using the services of the operating system (OS) on the UE 210. Once a connection is set up over RAT B 218, the traffic flow is routed over that connection by the UE 210. As explained above, a signalling connection may still optionally be maintained on RAT A 216. After switching to RAT B 218, an analogous process to that described above may be used to monitor a candidate cell of RAN A 220 such that the switching server 310 may determine whether or not the UE 210 should switch its traffic flow back to RAT A 216 (in which case, a signalling connection on RAT B 218 may still optionally be maintained).

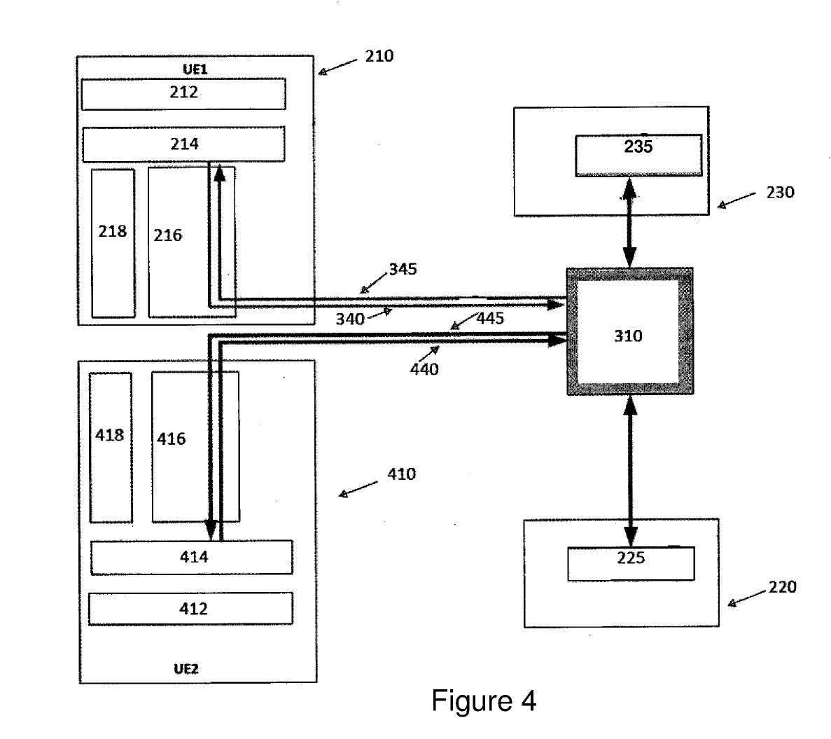

FIG. 4 shows a further aspect of the present disclosure whereby load status information is used to exercise global management of access technologies. Whilst representations of the internet 240, core network A 228 and core network B 238 have been omitted from FIG. 4, and the IP connections 340, 345 are not shown to pass through RAN A 220, this is for the sake of clarity of the drawing only. It will be understood that IP connections between the UE 210 and load servers are formed via a serving RAN, corresponding core network and the internet in the same way as shown in FIG. 2 and described above.

The arrangement shown in FIG. 4 is similar to that of FIG. 3, but further comprises a second UE 410. The second UE 410 comprises an application 412 and a UE client 414 and is configured to carry a connection using RAT A 416 and/or RAT B 418.

In this aspect of the disclosure, the switching server 310 does not make an isolated RAT decision for each UE, but considers the situation of all UEs in a serving cell of an access network and which UEs are also within the coverage of candidate access networks. On the basis of these global considerations, the switching server 310 may make a global decision on which UEs should maintain their traffic flow on their serving cell and which UEs should switch their traffic flow to a cell of a candidate access network.

When a UE 210, 410 connects to a cell (the serving cell) in RAN A 230 (the serving access network), the UE client 214, 414 may send the switching server 310 an IP packet via RAT A 216, 416 comprising an identifier of the serving cell of the RAN A 230 and the current IP address of the UE 214, 414 (which is assigned by the RAN A 230 for the UE's current connection). The IP address of the UE 214, 414 acts both as an address for later data transmission from the switching server 310 to the UE 214, 414 and as a unique UE 214, 414 identifier. The UE client 214 transmits the IP packet on the user plane of IP connection 340 as explained in respect of the aspect of the disclosure shown in FIG. 3 and the UE client 414 transmits the IP packet on the user plane of an IP connection 440 in an analogous manner. In this way, the switching server 310 is aware of all of the UEs under the coverage of a cell of RAN A 230.

When a UE 214, 414 changes its serving cell, for example due to handover, it may update the switching server 310 with an identifier of the UE's new serving cell of the RAN A 230. If the IP address assigned to the UE 214, 414 changes, the UE 214, 414 may also update the switching server with its new IP address in the same way. In this way, the switching server 310 may be aware, at any given time, of the UEs utilising each cell of RAN A 230 and their respective IP addresses.

In addition to sending the identifier of the UE's serving cell and IP address to the switching server 310, the UE client 214, 414 may optionally also include in the IP packet an identifier of any cell(s) (a candidate cell) of RAN B 220 (the candidate RAN) whose coverage they are within. If RAN B 220 is a WLAN network, this may comprise at least one of the MAC address of the cell and/or an identifier of the network(s), for example an SSID(s). The UE 210 may consider if the SSID(s) of the candidate cell are valid, based on the UE's subscription policy, and identify only a valid MAC address and/or network SSID(s) in the IP packet. This information may enable the switching server 310 to build a map of the cells of RAN B 220 that are within the coverage area of the serving cell of RAN A 230. The map may later be used by the switching server 310 to identify in which RAN A 230 cell a UE 210 is located on the basis of a reported RAN B 220 cell (which is useful if the UE 210 does not report to the switching server 310 in which RAN A 230 cell they are).

The switching server 310 is configured to use the IP address that it has for every UE operating on the serving cell of RAT A 230 to establish an IP connection (IP connection 345 to UE 210 and IP connection 445 to UE 410) on RATA 216, 416 to each UE 210, 410 and transmit on the user plane a request for information. The switching server 310 may transmit the request for information, for example, when load server A 235 indicates that the serving cell of RAT A 230 is heavily loaded.

The request for information transmitted from the switching server 310 to the UEs 210, 410 may prompt the UE client 214, 414 to send on the user plane of their IP connections 340, 440 at least one of the following to the switching server 310:
1) An identifier(s) of a valid cell(s) of RAN B 220 whose coverage the UE 210, 410 is within (if this information has not already been received by the switching server 310 in the IP packet described above within a validity period).
2) Information regarding a received signal strength from a beacon(s) of the cell(s) of RAN B 220 whose coverage the UE 210, 410 is within. For example, if RAN B 220 is a WLAN network, this may be the received signal strength indicator (RSSI) of the access point(s) (AP) for the WLAN. Additionally, or alternatively, information regarding interference conditions (i.e. SNR) for the signal from a beacon(s) of the cell(s) of RAN B 220 whose coverage the UE 210, 410 is within
3) Information regarding the loading status of the cell(s) of RAN B 220 whose coverage the UE 210, 410 is within. The UE 210, 410 may obtain this information if it is advertised by the cell(s) of RAN B 220, which may be the case if RAN B 220 is a WLAN network. Additionally, or alternatively, the UE 210, 410 may directly request load status information from load server B 225 in the same way as described in respect of the aspect shown in FIG. 2. The switching server 310 may additionally or alternatively obtain load status information of the cell(s) of RAN B 220 by using the reported identifier(s) of the cell(s) to request the information from load server B 225.
4) Information regarding the serving cell of RAN A 230. The UE 210, 410 may be information obtainable by measuring at least one indicator of the connection quality on the serving RAT A 230 (which have been described earlier) and/or by directly requesting load status information from load server A 235 in the same way as described in respect of the aspect shown in FIG. 2. The switching server 310 may additionally or alternatively obtain load status information of the serving cell of RAN A 230 by using the reported identifier of the serving cell (or a deduced identifier of the serving cell based on the reported candidate cell identifier and cell mapping information that switching server 310 has built up, if the UE 310 has not reported its serving cell identifier) to request the information from load server A 235.

The switching server 310 may then use an algorithm to determine how to distribute the RATs used by UE's located within range of the serving cell of RAN A 230. The algorithm may be similar to that described in respect of the aspect shown in FIG. 3 and consider the connection quality of the serving cell of RAN A 230 and the load status of a candidate cell(s) of RAN B 220, but also consider at least one of:
a) The number of UEs within the coverage of the serving cell of RAN A 230 that are also within coverage of a cell(s) of RAN B 220.
b) Information regarding the signal strength of the cell(s) of RAN B 220 received at the UE(s) 210, 410 and/or SNR.
c) The number of UEs within coverage of the candidate cell(s) of RAN B 220.
d) The load status of all of the cells of RAN B 220 that are within the coverage of the serving cell of RAN A 230.

The nature and details of the algorithm may depend on the type and quantity of information being used. The skilled person will appreciate that the algorithm may be any algorithm suitable for exercising global management of access technologies for one or more UEs.

For example, if a UE 210 is at the edge of the serving cell of RAN A 230 and is within coverage of a candidate cell of RAN B 220, and if the loading status and coverage conditions of the candidate cell of RAN B 220 are good, the switching server 310 may determine that UE 210 should switch its traffic flow from RAT A 216 to RAT B 218.

However, if several UEs are within the coverage of the serving cell of RAN B 220 and all of the UEs are close to the base station of the serving cell of RAN A 220, the switching server 310 may decide that none of the UEs should switch from RAT A 216 to RAT B 218. Alternatively, the switching server 310 may decide that only a subset of all of the UEs within the coverage of RAN B 220 should switch their traffic flow from RAT A 216 to RAT B 218 in order to avoid the load on a cell(s) of RAN B increasing significantly, which may result in a poor user experience upon switching. Which UEs are within the subset for switching RAT may be determined in consideration of a number of different factors, including at least one of received signal strength at each for UE for RAT A 216 and/or RAT B 218 and load status of each cell of RAN B 220.

When the switching server 310 determines that a UE 210, 410 with a connection on serving RAT 216 should switch its traffic flow to a different RAT, it may send an instruction on the user plane of the IP connection 345, 445, triggering the UE client 214, 414 to carry out that switch, as described in respect of the aspect shown in FIG. 3.

Making such global decisions enables the switching server 310 to help balance the load between the serving cell of RAN A 230 and the cell(s) of RAN B 220.

A number of modifications or alternative to the above described aspects of the present disclosure may be implemented.

For example, rather than making a determination of the load status of the candidate cell, a determination may be made of a characteristic indicative of an expected quality for a connection between the user terminal and a candidate cell of the candidate access technology. Rather than making a determination of the load status of the serving cell, a determination may be made of the user terminal's connection quality on the serving cell. The decision of whether or not to switch the traffic flow from the serving cell to the candidate cell may be made by a comparison of the characteristic indicative of an expected quality for a connection between the user terminal and a candidate cell of the candidate access technology and the user terminal's connection quality on the serving cell.

The characteristic indicative of an expected quality for a connection between the user terminal and a candidate cell of the candidate access technology may be determined on the basis of at least one of: an indicator of the load status of the candidate cell and/or at least one measure relevant to the expected quality for connection between the user terminal and the candidate cell (for example, a measurement by the user terminal of the radio conditions of the candidate cell, for example received signal strength and/or SNR).

The user terminal's connection quality on the serving cell may be determined on the basis of at least one of: an indicator of the load status of the serving cell and/or at least one measure relevant to the connection on the serving cell (for example, an achieved throughput for user data and/or at least one measurement of at least one ping performed by the user terminal and/or radio conditions of the serving RAT, which may include, for example, a received signal strength of the serving cell and/or interference conditions at the user terminal, such as signal to noise ratio).

The UEs may be any mobile or stationary terminals that are capable of sending and/or receiving information using at least two radio access technologies (RAT). The radio access technologies may be any means by which the UE may send or receive data, for example licenced cellular technologies such as EDGE, UTMS or LTE, or unlicenced technologies such as WLAN or WiMAX, or any other type of RAT.

RAT A may be any type of RAT and RAT B may be any other type of RAT. Thus, in the above described aspects, it may be determined whether or not a UE should switch its traffic flow from a current connection on UTMS to a connection on WLAN, or from a current connection on UTMS to a connection on LTE, or from a current connection on WLAN to a connection on EDGE etc.

Whilst the above described aspects consider only a comparison of a serving cell of RAN A 230 against a candidate cell of RAN B 220, any number of additional RANs may be considered. For example, it may be determined whether or not a UE should switch its traffic flow on RAN A 230 to a candidate cell of RAN B 220, or to a candidate cell of RAN C, or to a candidate cell of RAN D. Information relating to the identity of each candidate cell of each RAN to be considered, and the load statuses etc of each RAN to be considered, may be obtained and utilised in the same way as that described above in respect of the candidate cell of RAN B 220.

Furthermore, whilst the above aspects of the present disclosure generally describe the consideration of a single candidate cell of RAN B 220, if the UE is within the coverage of two or more candidate cells of RAN B 220 (or any other candidate RANs), each of those candidate cells may be included in the consideration of whether the UE should switch its traffic flow and to which candidate cell.

The term ‘cell’ as used above is intended to encompass the coverage of a beacon or access point of a RAN, such as a macrocell, a femtocell, a picocell, a hotspot etc. For example, where the RAN is a cellular RAN, for example EDGE, UTMS or LTE, a ‘cell’ is the coverage area of a beacon of the RAN. Where the RAN is ‘non-cellular’ RAN, for example WLAN or WiMAX, a ‘cell’ is the coverage area of an access point (AP) of the RAN.

Whilst some specific examples of cell identifiers have been described above, it will be understood that any means of uniquely identifying a serving cell or a candidate cell may be used.

Communications between the UE(s) 210, 410 and load server(s) (225, 235), between the UE(s) 210, 410 and switching server 310, and between the switching server 310 and the load server(s) (235, 235) may take place directly, as shown in FIGS. 2, 3 and 4, or via any number of intermediate elements. Thus, for example, when the UE 210 sends a transmission to the switching server 310, it may do so via any number of intermediate network elements.

A load server in accordance with the above described aspects may be configured to monitor at least one aspect of the load status of one or more cells in a single RAN, or monitor at least one aspect of the load status of one or more cells in two or more different RANs. The load server may include a database (or any other means for storing and retrieving data), using which it may store and look up load status information of at least one cell, or it may have access to a database (or any other means for storing and retrieving data) for the same purpose at a different location to the load server.

Whilst the UEs shown in FIGS. 2, 3 and 4 all include an application 212, 412 that may require a connection for operation, it will be understood that the UEs may not have any applications at all, or may have two or more different applications. Furthermore, the client 214, 414 described in the above aspects of the disclosure may be any entity within the UE 210, 410 that is configured to perform the above described functionality.

Some specific examples of information that may be used to indicate the load status of a cell is described above, for example air interface resource usage on uplink and/or downlink etc, although it will be understood that any information that may be used to determine the load status of a serving cell or candidate cell may be used.

The algorithm used to determine whether or not a UE should switch RAT may take any form that enables a decision regarding switching to be made. For example, it may or may not be configured to favour the UE using a particular RAT, for example using WLAN if this is considered to be generally more cost effective for users, or to place more importance on some load status indicators than other load status indicators, etc.

In the aspects described in respect of the arrangement of FIG. 4, the switching server 310 may consider the operation of any number of UEs and make a global decision of what RAT all of the considered UEs should use. The considered UEs may all be on the same serving cell of the same RAN, or may be on different serving cells of the same RAN, or may be on different serving cells of different RANs. In this way, for example, the switching server 310 may determine that a first UE should remain on a cell of RAN A 230, a second UE should switch from the cell of RAN A 230 to a first cell of RAN B 220, a third UE should switch from a second cell of RAN B 220 to the cell of RAN A 220, that a fourth UE should switch from the first cell of RAN B 220 to a cell of RAN C, etc etc.

In the above described aspect shown in FIG. 4, it is explained that switching server 310 may begin considering possible switching of UE access technologies when a load server indicates that a serving cell is heavily loaded. The switching server 310 may regularly request a notification of loading from all cells for which it is responsible, in response to which the loading servers may indicate if they are heavily loaded or not, and/or the load server(s) may be configured to push the information to the switching server 310 either periodically or when a cell is heavily loaded. Additionally or alternatively, the switching server 310 may be configured periodically to consider possible switching of UE access technologies regardless of whether or not any cells are heavily loaded, for example so that regular load balancing may take place and/or improvements in user's data experiences may be made.

1. A switching selector configured to control a selection of a radio access technology (RAT) for traffic flow of a user terminal between a serving RAT and a candidate RAT, wherein the switching selector comprises:
a status module configured to determine a characteristic indicative of an expected quality for a connection between the user terminal and a candidate cell of the candidate RAT using information received on a user plane of a connection on the serving RAT; and
a comparison module configured to determine whether the user terminal should change its traffic flow on the candidate cell of the candidate RAT or maintain its traffic flow on a serving cell of the serving RAT on the basis of a comparison between the user terminal's connection quality on the serving cell of the serving RAT and the characteristic indicative of an expected quality for a connection between the user terminal and the candidate cell of the candidate RAT.

2. The switching selector of claim 1, wherein the status module is further configured to:
determine the characteristic indicative of an expected quality for a connection between the user terminal and the candidate cell of the candidate RAT using one or more of;
at least one indicator of load status of the candidate cell of the candidate RAT received from a candidate RAT load server; and
a measure relevant to the expected quality for a connection between the user terminal and the candidate cell of the candidate RAT.

3. The switching selector of claim 2, wherein the measure relevant to the expected quality for a connection between the user terminal and the candidate cell of the candidate RAT comprises at least one measurement performed by the user terminal of at least one parameter relevant to a candidate cell signal received by the user terminal.

4. The switching selector of claim 1, further comprising:
a connection status module configured to determine the user terminal's connection quality on the serving cell of the serving RAT using one or more of: at least one indicator of a load status of the serving cell of the serving RAT received from a serving RAT load server; and
a measure relevant to the user terminal's connection quality on the serving cell of the serving RAT.

5. The switching selector of claim 4, wherein the measure relevant to the user terminal's connection quality on the serving cell of the serving RAT comprises at least one measurement performed by the user terminal of at least one parameter relevant to the user terminal's connection quality on the serving cell of the serving RAT.

6. The switching selector of claim 4, wherein the switching selector forms part of the user terminal, and wherein:
the at least one indicator of the load status of the serving cell of the serving RAT is received on the user plane of the serving RAT from the serving RAT load server in response to a request for the at least one indicator of the load status of the serving cell of the serving RAT sent by the connection status module on the user plane of the serving RAT; and/or
the connection status module is further configured to perform at least one measurement of at least one parameter relevant to the user terminal's connection quality on the serving cell of the serving RAT.

7. The switching selector of claim 4, wherein the switching selector
forms part of a network server, and wherein:
the connection status module is further configured to obtain from a serving RAT load server at least one indicator of the load status of the serving cell of the serving RAT using an identifier of the serving cell received on the user plane of the serving RAT from the user terminal; and /or
the connection status module is further configured to receive from the user terminal, on the user plane of the serving RAT, the measure relevant to the user terminal's connection quality on the serving cell of the serving RAT.

8. The switching selector of claim 1, wherein the switching selector forms part of the user terminal and the information used to determine the characteristic indicative of an expected quality for a connection between the user terminal and a candidate cell of the candidate RAT comprises at least one indicator of:
a load status of the candidate cell of the candidate RAT; and/or
a measure relevant to the expected quality for a connection between the user terminal and the candidate cell of the candidate RAT.

9. The switching selector of claim 8, wherein:
the status module is further configured to cause a transmission, on the user plane of the serving RAT, from the user terminal to a candidate RAT load server of a request for at least one indicator of the load status of the candidate cell of the candidate RAT when it is determined that the user terminal is within the candidate cell of the candidate RAT, wherein the request comprises an identifier of the candidate cell of the candidate RAT; and/or the status module is further configured to perform at least one measurement of at least one parameter relevant to a candidate cell signal received at the user terminal.

10. The switching selector of claim 1, wherein the switching selector forms part of a network server, and the information used to determine the characteristic indicative of an expected quality for a connection between the user terminal and a candidate cell of the candidate RAT comprises at least one of:
an identifier of the candidate cell of the candidate RAT, wherein the status module is further configured to obtain from a candidate RAT load server at least one indicator of the load status of the candidate cell of the candidate RAT using an identifier of the candidate cell and determine the characteristic indicative of an expected quality for a connection between the user terminal and a candidate cell of the candidate RAT using the at least one indicator of the load status of the candidate cell of the candidate RAT; and/or
a measure relevant to the expected quality for a connection between the user terminal and the candidate cell of the candidate RAT.

11. The switching selector of claim 10, wherein the switching selector further comprises:
a request module configured to cause a transmission, on the user plane of the connection on the serving RAT, from the network server to the user terminal of a request for at least one of:
the identifier of the candidate cell of the candidate RAT; and/or the measure relevant to the expected quality for a connection between the user terminal and the candidate cell of the candidate RAT.

12. The switching selector of claim 10, wherein the switching selector further comprises:
a request module configured to cause a transmission, on the user plane of the connection on the serving RAT, from the network server to the user terminal of at least one of:
a request for an identifier of the serving cell of the serving RAT; and/or a request for the measure relevant to the expected quality for a connection between the user terminal and the candidate cell of the candidate RAT.

13. The switching selector of claim 10, further comprising:
an instruction module configured to cause a transmission from the network server to the user terminal, on the user plane of the connection on the serving RAT, of an instruction for the user terminal to change its traffic flow to the candidate cell of the candidate RAT when the comparison module has determined that the user terminal should change its traffic flow to the candidate cell of the candidate RAT.

14. The switching selector of claim 10, wherein the comparison module is further configured to determine whether the user terminal should change its traffic flow to the candidate cell of the candidate RAT or maintain its traffic flow on the serving cell of the serving RAT also on the basis of at least one of:
the number of user terminals within coverage of the serving cell of the serving RAT;
the number of user terminals within coverage of the serving cell of the serving RAT that are also within a coverage of at least one cell of the candidate RAT;
a received signal strength of the serving RAT at other user terminals within a coverage of the serving cell of the current RAT;
a received signal strength of any cells of the candidate RAT at any other user terminals within a coverage of the candidate cell of the candidate RAT; and
a load status of any cells of the candidate RAT that are within the coverage of the serving cell of the serving RAT.

15. A load server configured to receive information from a user terminal on a user plane of the user terminal's connection on a serving radio access technology (RAT) and to cause the transmission of information from the load server to the user terminal on the user plane of the user terminal's connection on the serving RAT, wherein the load server comprises:
a load status indicator module configured to identify at least one indicator of a load status of a cell of an RAT in response to a request received from the user terminal on the user plane of the user terminals' connection on the serving RAT; and
a response module configured to cause a transmission to the user terminal, on the user plane of the user terminal's connection on the serving RAT, of the requested at least one indicator of the load status of the cell of the RAT.

16. A method for controlling a selection of a radio access technology (RAT) for traffic flow of a user terminal, the method comprising the steps of:
receiving information on a user plane of a serving RAT; using the received information to determine a characteristic indicative of an expected quality for a connection between the user terminal and a candidate cell of a candidate RAT;
comparing the user terminal's connection quality on a serving cell of the serving RAT to the characteristic indicative of the expected quality for a connection between the user terminal and the candidate cell of the candidate RAT; and
determining on the basis of the comparison whether the user terminal should change its traffic flow to the candidate cell of the candidate RAT or maintain its traffic flow on the serving cell of the serving RAT.
